(19) United States
(12) Patent Application Publication
(10) Pub. No.: US 2026/0167075 A1
(43) Pub. Date: Jun. 18, 2026

(54) FASTENING ARRANGEMENT FOR FASTENING A PUMP HOUSING, HOLDING DEVICE, PUMP ARRANGEMENT, VEHICLE SEAT, MOTOR VEHICLE

(71) Applicant: Volkswagen Aktiengesellschaft, Wolfsburg (DE)

(72) Inventors: Martin KOSCHE, Gifhorn (DE); Johann GIGGEL, Gardelegen (DE); Ralph BOETTGER, Ebendorf (DE); Viktor PETKER, Wolfsburg (DE)

(73) Assignee: Volkswagen Aktiengesellschaft, Wolfsburg (DE)

(21) Appl. No.: 19/419,965

(22) Filed: Dec. 15, 2025

Related U.S. Application Data
(63) Continuation of application No. PCT/EP2024/065531, filed on Jun. 6, 2024.

(30) Foreign Application Priority Data
Jun. 15, 2023 (DE) 10 2023 205 621.6

(51) Int. Cl. B60N 2/66

(52) U.S. Cl. CPC B60N 2/665

(57) ABSTRACT

A fastening arrangement for fastening a pump housing, in particular for an adjustable lumbar support, having a frame element of a vehicle seat, and having at least one holding device designed for arranging the pump housing on the frame element and fastening it thereto. The holding device has at least one rear-engagement element and an alignment element. Provision is made that the alignment element can be or is plugged into a recess in the frame element in a manner at least substantially free of play so as to pre-mount the holding device on the frame element with a secured orientation.

This nonprovisional application is a continuation of International Application No. PCT/EP2024/065531, which was filed on Jun. 6, 2024, and which claims priority to German Patent Application No. 10 2023 205 621.6, which was filed in Germany on Jun. 15, 2023, and which are both herein incorporated by reference.

### BACKGROUND OF THE INVENTION

### Field of the Invention

The invention relates to a fastening arrangement for fastening a pump housing, in particular for an adjustable lumbar support, having a frame element of a vehicle seat, and having at least one holding device designed for arranging the pump housing on the frame element and fastening it thereto, wherein the holding device has at least one rear-engagement element and an alignment element.

In addition, the invention relates to a holding device, in particular for such a fastening arrangement; a pump arrangement having such a holding device; a vehicle seat for a motor vehicle having such a fastening arrangement or having such a pump arrangement; and a motor vehicle having such a vehicle seat.

### DESCRIPTION OF THE BACKGROUND ART

Fastening arrangements of the abovementioned type are known from the prior art. Thus, for example, a pump device for creating pneumatic pressure, which is arranged in a vibration-isolated manner in a retaining mechanism and is connected thereby in a fixed position to a tubular frame of a motor vehicle seat, is known from published patent application DE 10 2008 020 436 A1, which is incorporated herein by reference. The fixed-position connection to the tubular frame is designed here as a clip attachment, wherein the retaining mechanism has U-shaped retaining feet by means of which the clip attachment to an element of the tubular frame is accomplished

Also known are pneumatic lumbar shield arrangements, for example for vehicle seats of motor vehicles, that permit an adjustment of the lumbar-vertebra support (lordosis) for a user-specific natural contour of the spinal column in the lumbar region (S-curve of the spinal column) via the filling of air cushions or air pockets which overlap, in particular in some areas. In this case, the supply of air is usually carried out by such pump devices with a pump motor. Filling, air evacuation, and maintaining of the air pressure are controlled by control devices and valve arrangements.

### SUMMARY OF THE INVENTION

It is therefore an object of the invention to provide an improved fastening arrangement that ensures simple mounting, with a secured orientation, of the pump housing on the frame element.

The object of the invention is attained by a fastening arrangement in which an alignment element can be or is plugged into a recess in the frame element in a manner at least substantially free of play so as to pre-mount the holding device on the frame element with a secured orientation. As a result, an advantageous, alternative solution for vibration-isolated attachment of a lumbar pump directly to the frame element is created that forgoes a tubular frame, and requires only a recess in the frame element. The attachment is vibration-isolated because the pump housing does not rest flat against the frame element and vibrations are not transmitted, reliably ensuring a low-acoustics and low-vibration attachment. In this respect, the holding device serves as an advantageous connecting element for pre-mounting as well as vibration isolation. At least one pump element preferably can be or is arranged in the pump housing. The pump element has, in particular, a pump motor or is designed as a pump motor. In particular, the pump housing and holding device constitute an especially advantageous pre-mounting unit. Preferably, the holding device is matched to one or more openings already present in the frame element in any case, and in this regard serves as an advantageous adapter element for the frame element. Especially preferably, the holding device can be or is arranged at the level of at least one of the air cushions associated with it so that the length of a connecting hose is advantageously minimized.

The holding device can be designed in one piece at least with a housing part of the pump housing. Owing to the one-piece design, the advantage results that the pump housing is fastened to the frame element especially simply, thus eliminating an additional mounting step for fastening the holding device to the pump housing. In addition, the one-piece design creates an especially advantageous possibility for jointly producing the pump housing and holding device, in which no additional production step is needed to produce the holding device, in particular.

The holding device can have a fastening point for connection, in particular interlocking connection, to at least one housing part of the pump housing. The holding device and the pump housing are thus designed to be separate from one another or in at least two parts. As a result, an especially advantageous possibility is created for separate optimization and designing of the geometry of the holding device, in particular for tailoring to different frame elements, with the pump housing remaining unchanged. In this regard, an advantageous modular system is created.

The rear-engagement element can be designed to engage behind the frame element in an interlocking manner through an opening, in particular an at least substantially circular opening, in the frame element. This results in the advantage that the pump housing is held especially securely on the frame element with the holding device.

The rear-engagement element can be L-shaped in cross section and is designed or arranged on the holding device to protrude from a contact plane of the holding device that is or can be associated with the frame element. It is advantageously ensured by this means that the holding device securely surrounds the frame element in an interlocking manner between the contact plane and the rear-engagement element.

The alignment element can have a projection protruding from a contact plane of the holding device that is or can be associated with the frame element. Owing to such a projection, the advantage results that the holding device with rear-engagement element and projection is fixed geometrically securely on the frame element.

The same opening can be or is associated with the alignment element as with the rear-engagement element, wherein the opening has a recess at the edge, corresponding geometrically to the projection, in particular diverging from a circular shape, for the alignment element. It is advantageously ensured by this means that the holding device is held in the frame element in a rotation-proof manner with just one opening.

A recess that is separate from the opening for the rear-engagement element and corresponds geometrically to the projection, in particular is at least substantially circular, can be or is associated with the alignment element. This results in the advantage that the holding device is held in the frame element in a rotation-proof manner with just one additional recess.

The holding device can have at least one receptacle for a retaining element, in particular a rivet, for securing the holding device on the frame element. It is advantageously ensured by this means that the holding device is held captively on the frame element. In particular, the retaining element can be plugged or is plugged into the receptacle through an opening in the frame element from a side of the frame element facing away from the holding device.

The holding device can have at least one support element for contact on the frame element. Owing to the support element, the advantage results that external forces acting on the holding device are securely supported on the frame element.

The holding device can have a truss structure for reinforcement, at least in some areas, of the holding device. The robustness of the holding device is advantageously further improved by the truss structure, but weight is advantageously reduced in comparison with a construction of solid material.

The holding device is, in particular, provided for the fastening arrangement according to the invention, and is characterized by at least one alignment element that has a projection protruding from a contact plane of the holding device, and at least one rear-engagement element that is L-shaped in cross section and is designed or arranged on the holding device to protrude from the contact plane of the holding device. The aforementioned advantages are produced by this means.

The pump arrangement has a pump element, in particular a pneumatic pump element, and a pump housing, in particular of an adjustable lumbar support of a vehicle seat, and is characterized by the holding device according to the invention. The aforementioned advantages are also produced by this means.

The vehicle seat for a motor vehicle is characterized by the fastening arrangement according to the invention or the pump arrangement according to the invention arranged on a frame element of the vehicle seat, in particular on a backrest. The aforementioned advantages are also produced by this means. The same advantages are produced with employment of the vehicle seat in other means of transport, in particular airplanes, as well as with a use of the fastening arrangement or pump arrangement according to the invention in seats that are not installed in means of transport, for example massage seats.

The motor vehicle is characterized by at least one vehicle seat according to the invention. The aforementioned advantages are also produced by this means. In particular, the motor vehicle has the vehicle seat as a driver's seat.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a backrest of a vehicle seat,

FIGS. 2A and 2B show fastening arrangements of the backrest,

FIGS. 3A and 3B show views of holding devices of the fastening arrangements,

FIGS. 4A and 4B show additional views of the holding devices, and

FIGS. 5A and 5B show additional views of the holding devices.

### DETAILED DESCRIPTION

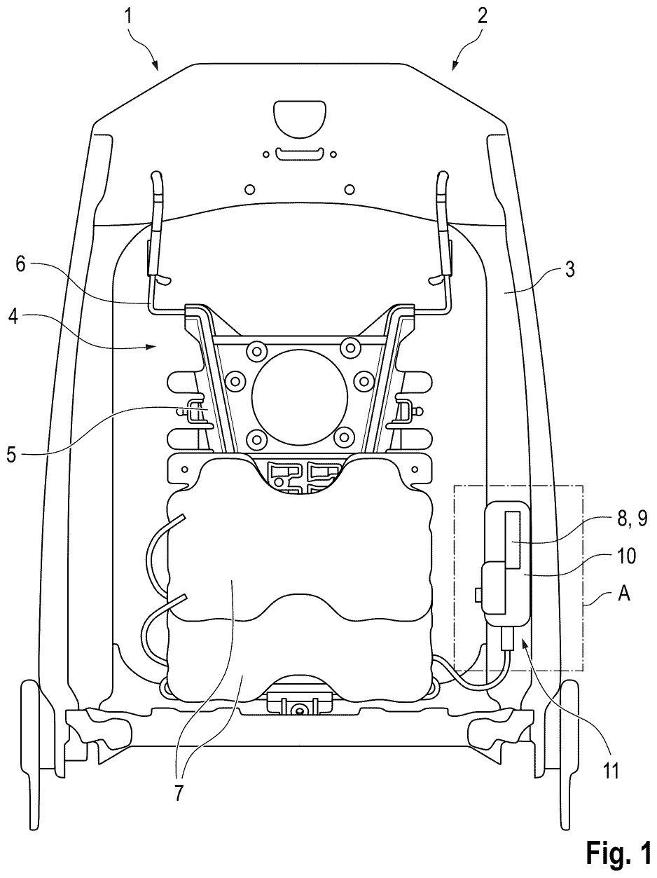

FIG. 1 shows a backrest 1 of a vehicle seat 2. The backrest 1 has a frame element 3, in which a lumbar shield arrangement 4 is mounted. The lumbar shield arrangement 4 has a lumbar shield 5 and a supporting rod 6 for suspending the lumbar shield 5 on the backrest 1. The lumbar shield 5 is suspended in the frame element 3 with the supporting rod 6.

Fastened to the lumbar shield 5 are two mutually overlapping air cushions 7 of an adjustable lumbar support, in particular as part of a massage function. The air cushions 7 are each connected via tubing to a pneumatic pump arrangement 8.

The pump arrangement 8 is likewise fastened to the frame element 3, in the present case in a lower half of the frame element 3 at the level of the air cushions 7. The pump arrangement 8 in the present case has a pump motor, not shown, arranged in a pump housing 9, and is fastened to the frame element 3 by means of a holding device 10.

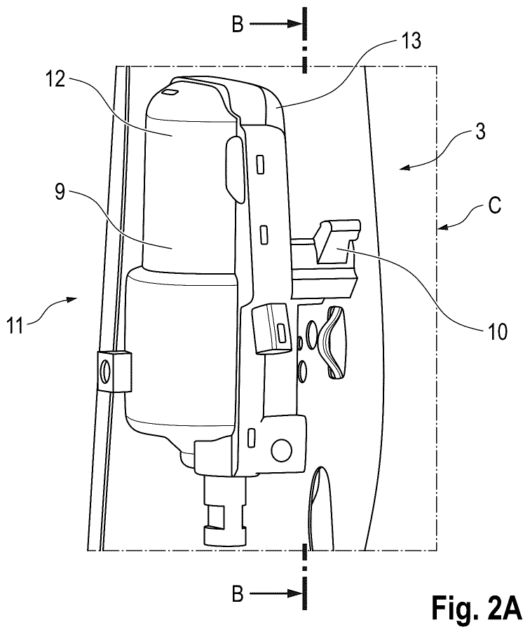

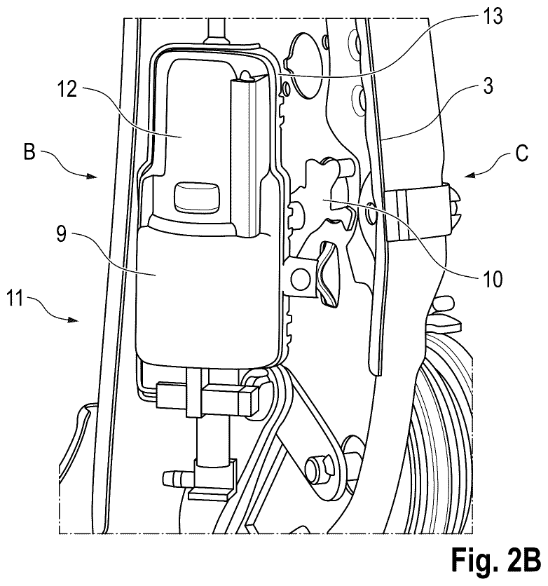

To this end, FIGS. 2A and 2B show first and second examples of advantageous fastening arrangements 11, each with the pump housing 9 fastened to the frame element 3 by means of the holding device 10. Shown in each case here is a detail A from FIG. 1. The pump housing 9 in the present case is designed in at least two parts in each case, and has a first housing part 12 and, connected thereto, a second housing part 13.

The examples differ, first of all, in that the holding device 10 in the first examples is designed in one piece with the second housing part 13 of the pump housing 8, and in the second examples is merely connected, in particular detachably, to the second housing part 13.

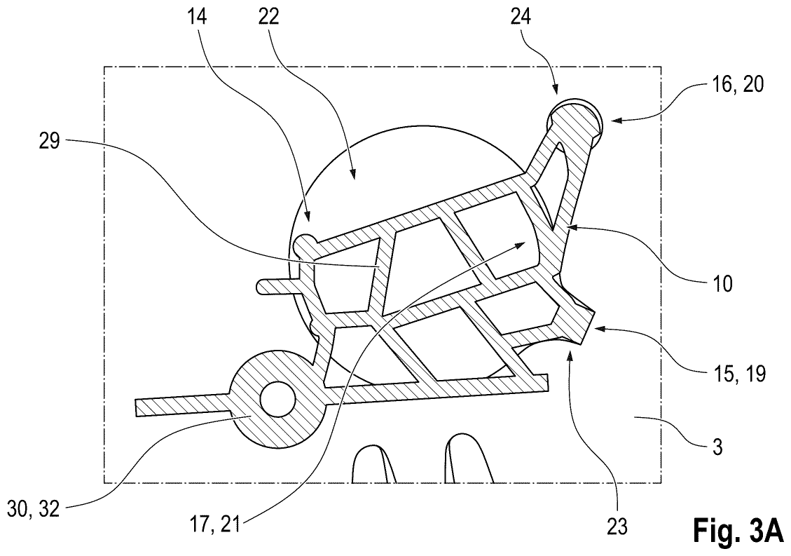

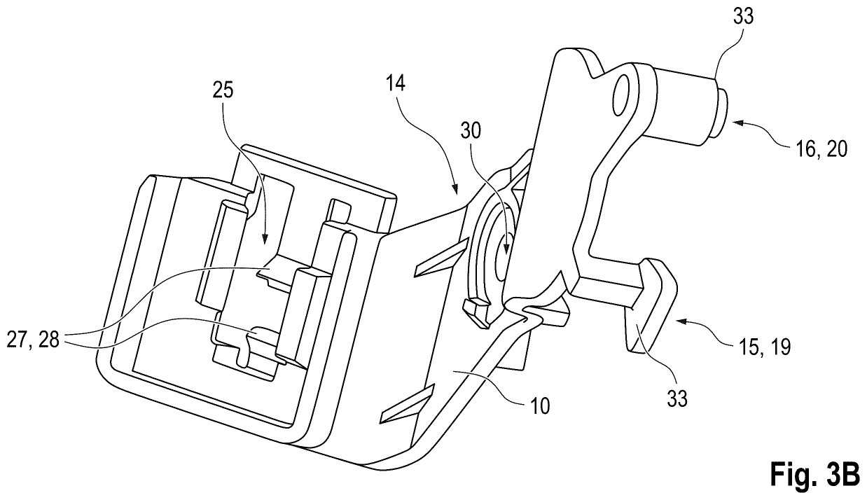

The holding devices 10 shall now each be described in greater detail. Because the holding devices 10 otherwise have great commonalities, they are described jointly as much as possible in the text below. FIGS. 3A to 5B show different views of the holding devices 10 here.

The first examples is shown in each case in FIGS. 3A, 4A, and 5A, and the second examples in FIGS. 3B, 4B, and 5B. FIG. 3A shows a sectional view through the section plane B-B drawn in FIG. 2A. FIG. 3B shows the holding device 10 in the perspective represented in FIG. 2B, which is to say from a direction of view B analogous to the section plane B-B.

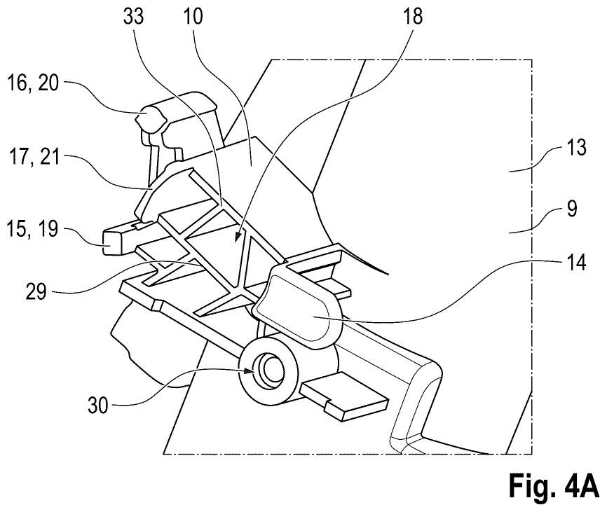

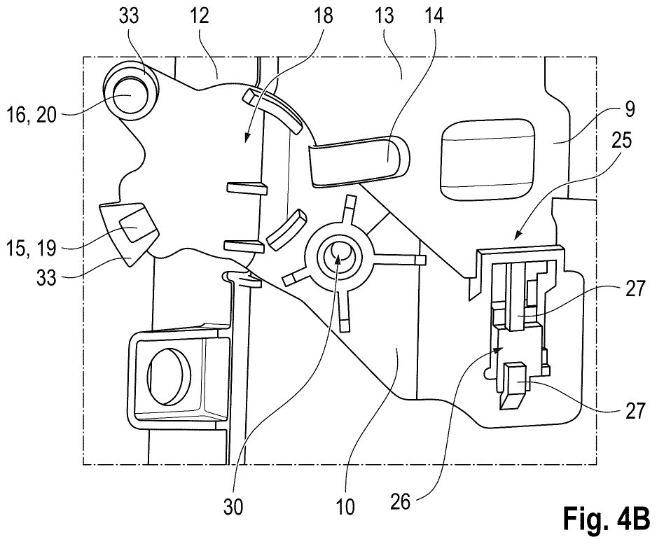

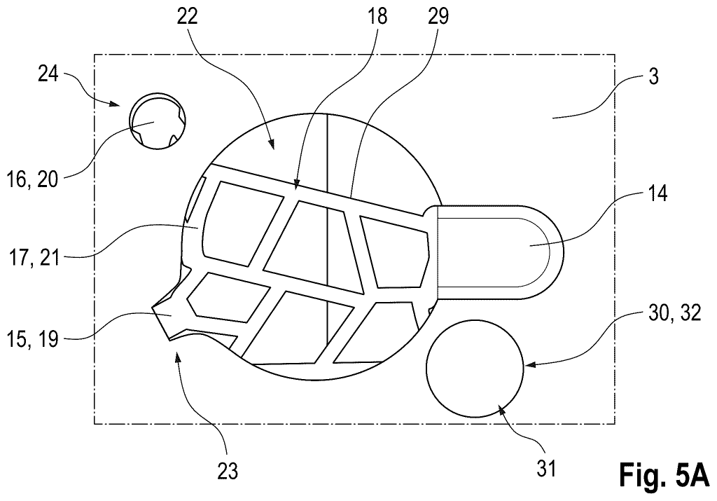

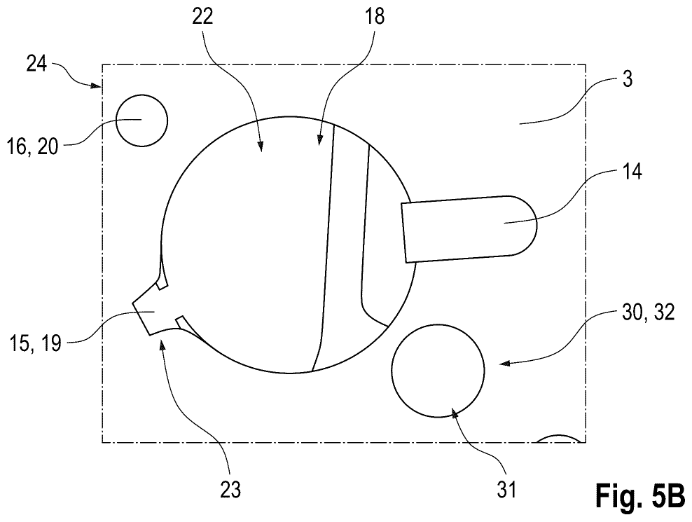

FIGS. 4A and 4B show a detail of the fastening arrangement 11 with the holding device 10 from a direction of view C drawn in each case in FIGS. 2A and 2B, without the frame element 3, which is to say in a non-mounted state. Finally, FIGS. 5A and 5B show a similar detail from the direction of view C, but with the frame element 3, which is to say in a mounted state.

The holding device 10 has one rear-engagement element 14 and multiple alignment elements 15, 16, 17 in each case. Thus, the holding device 10 in the first examples has a first alignment element 15, a second alignment element 16, and a third alignment element 17. The holding device 10 in the second examples has a first alignment element 15 and a second alignment element 16.

Each of the alignment elements 15, 16, 17 has a projection protruding from a contact plane 18 of the holding device 10 that is or can be associated with the frame element 3. Thus, the first alignment element 15 has a first projection 19, the second alignment element 16 a second projection 20, and the third alignment element 17 a third projection 21.

At least the first and the second alignment element 15, 16 each can be or is plugged into a recess in the frame element 3 in a manner at least substantially free of play so as to pre-mount the holding device 10 on the frame element 3 with a secured orientation.

In this design, a first opening 22 in the frame element 3 can be or is associated with the first alignment element 15 and the third alignment element 17 in each case, namely the same opening as with the rear-engagement element 14. The opening 22 in each case has a first recess 23 at the edge, corresponding geometrically to the projection 19, in the present case diverging from a circular shape, for the alignment element 15.

The projection 19 is designed to be at least approximately square in the present case, so the recess 23 also is at least substantially square. The opening 22 in the present case is otherwise at least approximately circular.

A second recess 24, separate from the first opening 22 for the rear-engagement element 14 and at least substantially circular in the present case, corresponding geometrically to the projection 20, which is at least substantially circular in the present case, can be or is associated with the second alignment element 16 in each case.

The rear-engagement element 14 is designed in each case to engage behind the frame element 3 in an interlocking manner through the first opening 22, in the present case at least substantially circular first opening, in the frame element 3. For this purpose, each rear-engagement element 14 is L-shaped in cross section and is designed or arranged on the holding device 10 to protrude from the contact plane 18 of the holding device 10 that is or can be associated with the frame element 3, so that the frame element 3 can be or is arranged between one of the legs of the rear-engagement element 14 and the contact plane 18.

Because the holding device 10 in the second examples is designed to be separate from the pump housing 9, the holding device 10 also has a fastening point 25 for connection, in the present case interlocking connection, to at least the second housing part 13 of the pump housing 9. The fastening point 25 corresponds geometrically to an applicable fastening receptacle 26 on the second housing part 13.

The fastening point 25 in the present case has two mutually opposite fastening elements 27, each with one additional rear-engagement element 28, that can be or are latched onto the fastening receptacle 26 in the manner of a clip connection.

In the first examples, the holding device 10 has a truss structure 29 for reinforcement, at least in some areas, of the holding device 10. In particular, the truss structure 29 forms the contact plane 18, at least in some areas.

The holding device 10 additionally has a receptacle 30 in each case for a retaining element 31, in the present case a rivet, for securing the holding device 10 on the frame element 3. For this purpose, the frame element 3 has a second opening 32, corresponding geometrically to the receptacle 30, into which the retaining element 31 can be plugged or is plugged into the receptacle 30 from the side of the frame element 3 facing away from the holding device.

Finally, the holding device 10 in each case also has at least one support element 33 for contact on the frame element 3. The support element 33 is designed, in particular, to be located in the contact plane 18, in each case as a contact surface against at least one of the projections 19, 20, 21 and/or as part of the truss structure 29.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A fastening arrangement for fastening a pump housing, in particular for an adjustable lumbar support, the fastening arrangement comprising:
a frame element of a vehicle seat; and
at least one holding device to arrange the pump housing on the frame element and fastening it thereto, the holding device having at least one rear-engagement element and an alignment element, the alignment element being adapted to be plugged into a recess in the frame element in a manner at least substantially free of play so as to pre-mount the holding device on the frame element with a secured orientation.

2. The fastening arrangement according to claim 1, wherein the holding device is designed in one piece at least with a housing part of the pump housing.

3. The fastening arrangement according to claim 1, wherein the holding device has a fastening point for connection or an interlocking connection to at least one housing part of the pump housing.

4. The fastening arrangement according to claim 1, wherein the rear-engagement element is designed to engage behind the frame element in an interlocking manner through an opening or through an at least substantially circular opening in the frame element.

5. The fastening arrangement according to claim 1, wherein the rear-engagement element is L-shaped in cross section and is designed or arranged on the holding device to protrude from a contact plane of the holding device that is associated with the frame element.

6. The fastening arrangement according to claim 1, wherein the alignment element has a projection protruding from a contact plane of the holding device that is associated with the frame element.

7. The fastening arrangement according to claim 5, wherein the same opening is associated with the alignment element as with the rear-engagement element, wherein the opening has a recess at an edge, corresponding geometrically to the projection or diverging from a circular shape, for the alignment element.

8. The fastening arrangement according to claim 5, wherein a recess that is separate from the opening for the rear-engagement element and corresponds geometrically to the projection or is at least substantially circular is associated with the alignment element.

9. The fastening arrangement according to claim 1, wherein the holding device has at least one receptacle for a retaining element or a rivet for securing the holding device on the frame element.

10. The fastening arrangement according to claim 1, wherein the holding device has at least one support element for contact on the frame element.

11. The fastening arrangement according to claim 1, wherein the holding device has a truss structure for reinforcement, at least in some areas, of the holding device.

12. A holding device for the fastening arrangement according to claim 1, comprising:
at least one alignment element that has a projection protruding from a contact plane of the holding device; and
at least one rear-engagement element that is L-shaped in cross section and is designed or arranged on the holding device to protrude from the contact plane of the holding device.

13. A pump arrangement comprising a pump element or a pneumatic pump element and comprising a pump housing of an adjustable lumbar support of a vehicle seat and comprising the holding device according to claim 12.

14. A vehicle seat for a motor vehicle comprising the fastening arrangement according to claim 1 arranged on a frame element of the vehicle seat or on a backrest.

15. A motor vehicle comprising at least one vehicle seat according to claim 14.
